(19) United States
(12) Patent Application Publication
(10) Pub. No.: US 2011/0272319 A1
(43) Pub. Date: Nov. 10, 2011

(54) OUTDOOR ENCLOSURE FOR ELECTRONIC EQUIPMENT AND METHOD FOR PROVIDING AN OUTDOOR ENCLOSURE FOR ELECTRONIC EQUIPMENT

(75) Inventors: Timo KOIVULUOMA, Vantaa (FI); Martti JUURIOKSA, Espoo (FI)

(73) Assignee: ABB OY, Helsinki (FI)

(21) Appl. No.: 13/072,265

(22) Filed: Mar. 25, 2011

(30) Foreign Application Priority Data
Mar. 26, 2010 (EP) 10158021.5

(51) Int. Cl. B65D 81/02; B23P 11/00

(52) U.S. Cl. 206/521; 29/428

(57) ABSTRACT

An enclosure and method for arranging an enclosure provides a robust and inexpensive enclosure for protection against gun fire and high temperature variations, in which method an enclosure having an inner shell and an outer shell en-closing the inner shell at a clearance thereof is formed, whereby a cavity is formed between the shells. Electrical equipment can be enclosed within the inner shell. Natural granular absorption material can be provided as the protective layer into the cavity on site upon installation of the enclosure.

### RELATED APPLICATION

This application claims priority under 35 U.S.C. §119 to European Patent Application No. 10158021.5 filed in Europe on Mar. 26, 2010, the entire content of which is hereby incorporated by reference in its entirety.

### FIELD

The present disclosure relates to shielding structures. Specifically, the disclosure relates to protective enclosures for equipment, such as electronic equipment, designed to protect the equipment from external impacts, such as, for example, gun fire and heat.

### BACKGROUND INFORMATION

Electronic equipment, such as frequency converters, can be housed safely indoors or in enclosures suited for outdoor use. Because some operations like oil drilling take place in environments which are considered hostile in terms of political disorder or vandalism, demand for suitable protective outdoor enclosures has grown. Sites where frequency converters are commonly used, like oil drilling areas, can suffer from a variety of threats. Many frequency converter cabinets have been subject to gun fire, and a useful feature in such a cabinet is protection against at least, Magnum .22 caliber fire. Because means of production, for example, pumps, are often situated in remote locations, there is a risk of being subjected to random shooting. Damages caused to remote means of production can cause costly stoppages in production.

There is a demand for electrical equipment enclosures conforming to the IEC 61969-1 standard concerning protection against gun fire. This standard defines, inter alia, protection against 12-gauge shotgun with No. 7 ½ size shot fired at a distance of 15 m. The standard provides that a load used shall be high brass shell fired from an improved or modified choke barrel. After being shot at, the outer shell of the enclosure may be deformed, for example, have dents in it, but it shall not feature protrusions. The protection must also prevent the ammunition from penetrating to an inside of the equipment compartment.

A known way to address shielding has been to employ thick metal on the shell of the enclosure or to use aramid material, such as Kevlar, to prevent penetration. However, there can be very little room for the metal to protrude into the equipment compartment. WO 2008/016295 A2 discloses a shelter including an outer wall of metal plate, an inner wall of metal plate and a heat-insulating layer between the outer wall and the inner wall. The corners of the enclosure are formed by welded seams, which connect parts of the inner wall or parts of the outer wall. A layer of bullet-proof or splinter-proof material can further be arranged between the outer wall and a heat-insulating layer.

In practice, known bullet-proof enclosures can be difficult to set up. Heavy-duty enclosures able to withstand intensive gunfire can be very heavy, whereby the thick metal plates are difficult to handle and to attach to the enclosure chassis. The set up work can also require many assemblers and heavy-duty hoisting equipment. However, U.S. Pat. No. 6,067,889 A discloses a portable and reusable bunker formed of hollow modules, which are assembled on the erection site and filled with water or sand. The weight issue could, to some extent, be addressed by using light-weight Kevlar fabrics. However, Kevlar can be too expensive to be used in many frequency converter enclosures, for example. Furthermore, known bullet-proof structures offer very little protection against vibration caused by gun fire, which can be just as destructive to electrical equipment as penetrative gun fire. Known structures also fail to offer protection against steep temperature variation between the heat by day and chill of the night.

### SUMMARY

A method is disclosed for providing a protective enclosure for equipment used in hostile environments. The method includes, an enclosure having an inner shell and an outer shell enclosing the inner shell at a clearance thereof, whereby a cavity is formed between the shells, enclosing the equipment within the inner shell, arranging granular absorption material as a protective layer into the cavity on site upon installation of the enclosure, and providing an insulation layer between the outer shell and the absorption material, for filling at least part of a bullet hole in the outer shell for preventing the absorption material from spilling out.

An outdoor equipment enclosure is disclosed including an inner shell for housing equipment, an outer shell enclosing the inner shell, a cavity arranged between the inner shell and the outer shell on at least a portion of the enclosure for receiving a layer of material for absorbing penetrative kinetic energy, wherein the enclosure is adapted to receive fillable granular absorption material into the cavity on site upon installation, and an insulation layer in the cavity on an inner surface of the outer shell, for filling at least part of a bullet hole in the outer shell for preventing the absorption material from spilling out.

### BRIEF DESCRIPTION OF THE DRAWINGS

In the following, exemplary embodiments of the disclosure are described with reference to the accompanying drawings, in which:

FIG. 1 presents a cross-section view of an enclosure according to one exemplary embodiment of the disclosure;

FIG. 2 presents an enclosure according to one exemplary embodiment featuring a heat pipe extending from inside the inner shell, through protective layers outside the outer shell;

FIG. 3 presents an enclosure according to one exemplary embodiment featuring heat exchanging unit arranged in an aperture in the enclosure wall; and

FIG. 4 presents a graph illustrating the thermal behavior of three different insulation arrangements in a two-layer enclosure.

### DETAILED DESCRIPTION

The enclosure according to exemplary embodiments of the disclosure can provide a robust and inexpensive enclosure for protection against gun fire and high temperature variations.

Enclosures will, most likely, be shot at with fairly light arsenal, which has been designed to be used by civilians for hunting purposes. The bullets used in recreational shooting are designed to bring an animal to a halt by transferring the kinetic energy of the bullet to the animal rather than penetrating it. As a result, a rather thin layer of a suitable kinetic energy absorbing material can be sufficient for protecting most enclosures against gun fire.

According to an exemplary embodiment of the disclosure, a hollow-core enclosure can be manufactured and then bullet-proofed on site upon set up. In the manufacture an inner shell can be made to enclose the electrical equipment. An outer shell can be made to enclose the inner shell at a clearance thereof, whereby a cavity is formed between the shells. Upon installation of the enclosure, granular absorption material can be arranged on site into the cavity as a protective layer. An additional insulation layer can also be provided between the outer shell and the absorption material, which layer can be adapted to fill at least part of a bullet hole in the outer shell for preventing the absorption material from spilling out.

The enclosure, according to an exemplary embodiment, can include an inner shell for housing the electrical equipment and an outer shell for enclosing the inner shell on areas where protection is desired. The enclosure includes a cavity arranged between the inner and outer shell on at least a portion of the enclosure for receiving a layer of bullet proofing material for absorbing penetrative kinetic energy. The enclosure can be adapted to receive fillable granular absorption material into the cavity on site upon installation of the enclosure. The enclosure can further include an insulation layer in the cavity on the inner surface of the outer shell, which layer can be adapted to fill at least part of a bullet hole in the outer shell for preventing the absorption material from spilling out.

According to one exemplary embodiment of the invention, the granular material can be sand, or any other suitable material.

Protection achieved with the disclosure is multifaceted. The protective layer having granular absorption material can offer protection against bullets, heat and explosions. In contrast to known methods of producing bullet-proof enclosures, the enclosure according to exemplary embodiments of the disclosure can be manufactured without heavy armor. Instead, the protective layer of absorption material can be added on site. As a result, the enclosure can be easy and fairly light to transport and handle, which convenience is emphasized during installation or setup of the enclosure.

Granular materials can be especially advantageous because they are inexpensive and capable of absorbing intensive impacts so that there is little or no requirement to design the enclosure to attenuate the impact. The absorption material is either very inexpensive or free and can be procured locally. In this respect, naturally occurring sand or a similar material, can be an ideal material for many applications. Granular absorption materials are also fluid enough to be flushed out if there is a need to move the enclosure. This would be difficult or impossible with Kevlar or sturdy metal plates, for example.

Natural granular materials can also protect against outdoor temperature changes, thermal radiation from the sun and to cold outdoor temperatures. This can also be important because electronic equipment does not respond well to high temperatures or temperature variation. Protection against the hot sun or cold can be achieved with a twin-wall structure, in which the outer surface cools or warms up through natural convection towards the outer temperature.

According to one exemplary embodiment, additional layers of, for example, rubber, wool or other porous material can be provided within the cavity for filling the possible bullet hole in the outer shell to prevent the absorption material from spilling out.

According to one exemplary embodiment, an auxiliary cooling arrangement can be provided with a heat pipe extending from inside the inner shell, through the protective layers outside the outer shell to improve the thermal efficiency of the enclosure.

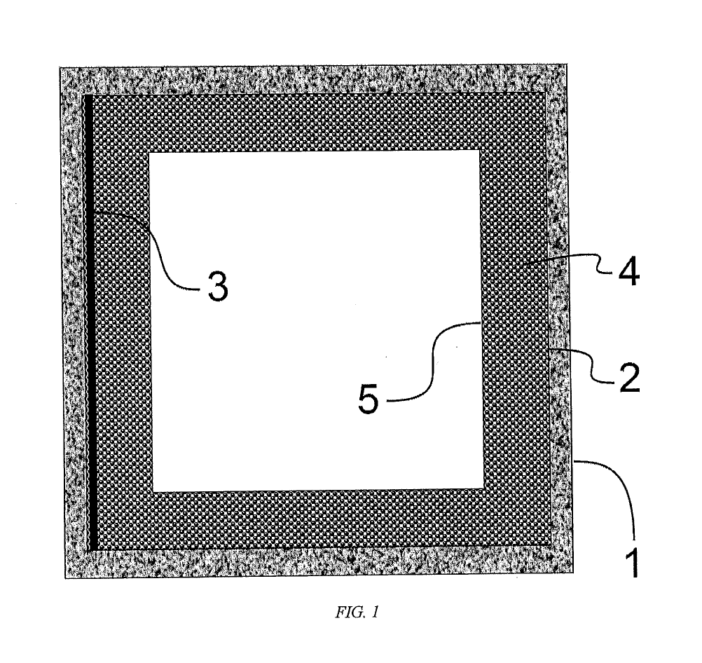

In an exemplary embodiment according to the disclosure, an enclosure can be manufactured to be equipped with protective material when the enclosure is installed. The enclosure can therefore be transported to the site without a protective element, for example, a protective layer of absorption material. Consequently, the enclosure can be made to have at least two nested shells, in between of which there is a cavity for receiving the protective element. As illustrated in FIG. 1, the enclosure has an inner shell 5 for receiving the electrical equipment. The electric equipment can be any equipment requiring protection, but one particular type of equipment usually requiring enhanced protection is frequency converters. This is because frequency converters are typically used on oil rigs and similar vulnerable operations, where the equipment is most likely to be subject to sudden gun fire.

The inner shell 5 encloses the equipment. In the manufacturing stage, a second outer shell 1 is formed on top of the inner shell 5 at a clearance thereof. The outer shell 1 is employed on surfaces, which are exposed to the environment. For example, if the enclosure is intended to be embedded to surrounding structure, such as a building wall, it would be sufficient to protect only the front face of the enclosure. In that respect the outer shell 1 encloses the inner shell 5, wherein it is arranged on top of the inner shell 5 on areas, which need protection. The clearance between the shells 1, 5 form a cavity for receiving and containing protective material 4. The connection between the shells 1, 5 is therefore arranged as secured as possible to form a closed space.

The shells can be made of any suitable material, for example, paintable sheet metal, such as aluminum plates, or even fiberglass sheets. The outer shell 1 does not have to be especially sturdy and it can, according to one exemplary embodiment, be made of interchangeable and quick clamping cover walls. The outer shell 1 can be made of steel, stainless steel, aluminum, plastics, glass fiber, or even wood. A suitable thickness can be about 0.5-5 mm. The inner shell 5, on the other hand, can be made of strong and plastic material, such as steel, stainless steel or aluminum with a thickness of about 0.5-5 mm.

The protective absorption material 4 can be fluid granular material, for example, with high density and specific heat capacity combined with low price and thermal conductivity. According to an exemplary embodiment, the material 4 can be sand. Sand is a particularly suitable material because there is a great abundance of sand in most environments in which enclosures according to the disclosure are needed, such as deserts where the sand is freely available. Furthermore, sand is available at a reasonable price everywhere in the world and can therefore be procured locally. In fact, most heavy enclosures require a foundation, which is typically made by pouring concrete. Thus, the inexpensive sand used in concrete can also be used as the absorption material. Above all, sand can be easily available and has suitable properties in terms of density (about 1515 kg/m3), thermal conductivity (about 0,27 W/mK) and heat capacity (800 J/ kg.K). Sand is therefore an outstanding material, which is dense enough to absorb kinetic energy, but fluid enough to stop the bullet smoothly. Sand can also prevent the bullet from ricocheting from the enclosure by capturing the bullet. Sand can also be capable of absorbing and releasing heat energy. For example, an enclosure door having dimensions of 600 mm×2000 mm with a 100 mm cavity filled with sand, would have a heat trap weighing around 200 kg and providing a thermal mass of about 150 kJ. With three walls carrying about 600 kg and 450 kJ/K would give, at temperature drop of 10 degrees in night time of 12 hours, an average extra heating effect of 20 W and in hottest daytime hours, for example from noon to 5 pm, an average thermal storage of 50 W without external power. Sun heats the mass of the cabinet during daytime. In deserts temperature variations can be tens of degrees even without the effect of direct sunshine. Inner parts of the cabinet also even out temperature differences.

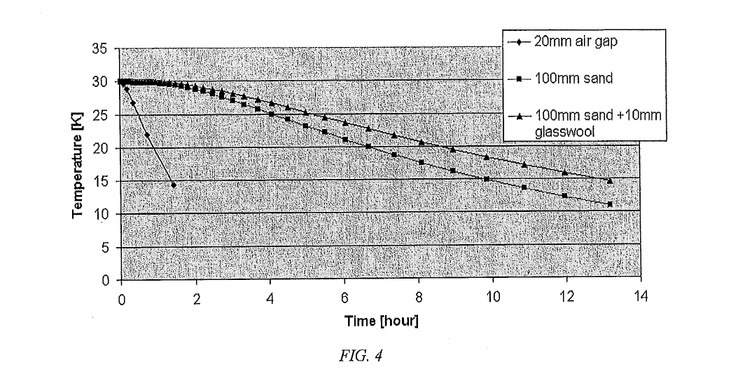

As illustrated in FIG. 4, adding mass can help to reduce the temperature variations of the enclosure during night, for example. In the case of FIG. 4, a 600 mm×600 mm×2000 mm cabinet was simulated with ambient wind speed of 1 m/s. The bottom of the enclosure is a one layer structure and the upper roof is permeable to gas, i.e., breathing, meaning that wind can go under the roof. The actual layers are made from 2 mm steel. As is apparent, the cabinet can cool down rather fast.

Three different insulating constructions were simulated:

20 mm air gap,
100 mm of sand, and
100 mm of sand provided with a 10 mm layer of glass wool.

As can be seen, providing the cabinet with stout insulation layer of sand with an additional layer of glass wool, can achieve the best result of the simulation options.

Soil could also be used due to great availability and suitable properties:

density of about 2050 kg/m3,
thermal conductivity of about 0,52 W/mK, and
heat capacity of about 1840 J/kg.K.

Sand can be preferable over soil because sand is usually quite fluid, i.e. easy to handle, and homogenous.

Other similar materials capable of absorbing kinetic and heat energy are also suitable. The material should be easily insertable into the cavity, i.e. be fluid. In addition to protection against gun fire, the protective layer of protective material 4 offers thermal protection. In another exemplary embodiment according to the disclosure minerals that melt and solidify in a suitable temperature, thus releasing or absorbing heat can be exploited. This would, however, require power and that the temperature is adjustable. One possible material would then be hydrochloric hydrate Rubitherm SP 25 A8 having a density of 1.38, a melting point of 26° C., a latent heat of solid/liquid phase change (hsf) of 180 kJ/kg, and heat capacity of 2,50 kJ/ kg.K. The described materials would also be light and take up little space.

Passive insulating thermal protection against ambient temperature variation can be reinforced with active heating or cooling methods, such as air-conditioning. Tubing required to arrange air-conditioning can be run through the absorption material so that they are protected and cannot act as a gateway into the enclosure.

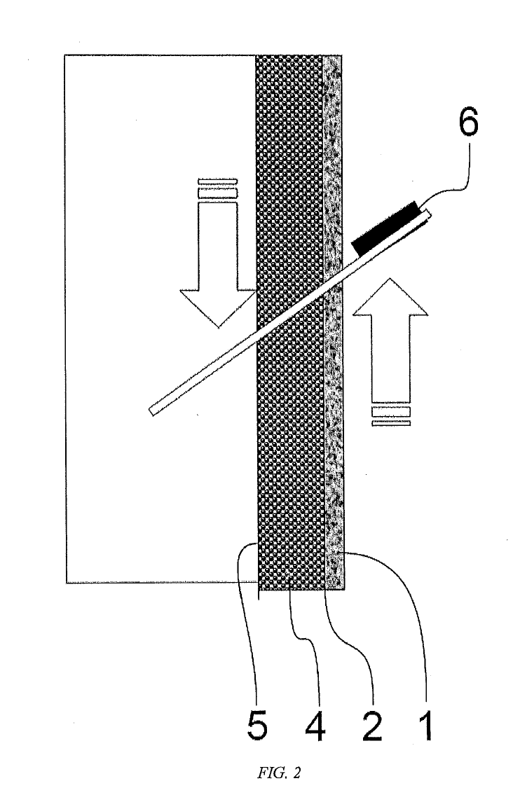

As illustrated in FIG. 2, an additional cooling arrangement could be provided through the use of a thermosyphon, particularly heat pipe 6, extending from inside the inner shell 1, through the protective layers 2, 4 outside the outer shell 5. Heat pipes are known per se. Heat pipes can be used for transferring heat from hot to cold.

As illustrated in FIG. 1 and according to one exemplary embodiment of the disclosure, the enclosure can be prismatic, wherein each face can be provided with the protective layer. FIG. 1 presents an assembled enclosure, but as described above, the enclosure is designed such that the cavity can be filled on site when the enclosure is installed. This means that the enclosure can be provided with an inlet for filling the cavity with absorption material upon assembly and an outlet for draining out absorption material upon maintenance or disassembly. The inner shape of the cavity is designed so that no fringe areas are formed so that the cavity can be filled evenly with the absorption material 4. The cavity may also need strengthening elements, such as connecting rods for connecting the inner and outer shell 1, 5 thus helping to prevent collapsing under the weight of the material 4. Because the enclosure can be transported from the factory to the site without the material 4, the enclosure can be fairly light to transport, handle and assemble.

A structure with multiple walls and subsequent cavities would also be possible.

According to one exemplary embodiment, the enclosure can be provided with an additional insulating layer 2 between the outer shell 1 and inner shell 5. The insulating layer 2 can be arranged onto the inner surface of the outer shell 1. The insulating layer 2 can be used to at least partially seal the hole made by a bullet penetrating the outer shell 5. This way the amount of lost protective material 4 can be minimized and the enclosure is able to withstand repetitive gun fire. A large variety of materials can be used for this purpose. For example, glass wool or rubber would be suitable. The material of the insulating layer 2 can be porous and has also heat-insulating properties. In this respect glass wool is a suitable material. Upon gun fire the outer shell 5 can therefore be designed to break and to let the bullet penetrate into the protective layer of absorption material 4. Residual kinetic energy of the bullet can be absorbed into the movement of the fluid material 4, whereby the solid structure of the enclosure does not have to yield. As the outer shell 5 has been penetrated, the insulating layer 2 seals the bullet hole preventing the fluid absorption material 4 from pouring out.

According to a further exemplary embodiment, the bullet-proofing of the enclosure is reinforced with an additional layer 3 of aramid fabric arranged between the outer shell 1 and inner shell 5. The aramid fabric can be Kevlar, for example.

According to one exemplary embodiment, the front wall, for example, the door, can be provided with an aramid fabric layer, such as Kevlar, and a thin layer of granular absorption material for reducing the weight of the front wall.

The shells 1, 5 can be made from a solid material having adequate strength to withstand impacts, but which is at least partially permeable to gas. Such material could be achieved by making minute holes into the shell 1, 5 by, for example, laser machining. Also a suitably dense mesh structure can be employed. Suitable mesh structures are known from metal screens used, for example, in cooking appliance hood filters. Alternatively dense mesh structures can be used as additional reinforcement inside the outer shell for protection against wild animals while being capable of allowing moisture to pass through. A similarly functioning layer can also be provided with a plurality of overlapping ribs.

Furthermore, only certain sides of the enclosure, such as the rear side, can use the gas permeable material. Also, the inlet and outlet lids can be made of the material exclusively or as auxiliary ventilation members. The porosity of the structure should be smaller than the grain size of the absorption material. Because the gas permeable structure is breathable, fumes developed inside or outside the enclosure can pass the enclosure walls while keeping the absorption material within the cavity. The absorption material can also have an additional insulation function, wherein it forms a sealing against dust and sparks. This can be especially advantageous in flour mills, chemical industry, oil drilling and similar flammably sensitive operations where explosions of arch generated within the enclosure due to an electrical failure could cause a fire. Conversely, the ability to filter fumes can be taken into account by overpressuring the enclosure for preventing flammable gases from entering the enclosure.

The absorption material has yet another function. In case of an internal explosion in the enclosure, the explosion causes flames to penetrate the gas permeable shells. Explosions occuring in frequency converter cabinets can be fierce, because the equipment contains large capacitors that trap large quantities of energy. In case of a short circuit, a crack in the power semiconductor insulation, for example, the capacitors can uncharge explosively. The problem can be amplified by power supply electricity until the blowout of fuses. By having absorption material, preferably sand or a similar material, in the double-shell cavity, the absorption material can either extinguish the flames or at least lower the temperature of the flames or explosion gas. For improved protection against internal explosions, the enclosure can be, according to one exemplary embodiment, equipped with a pressure balancing tube for exhausting abrupt overpressure within the enclosure.

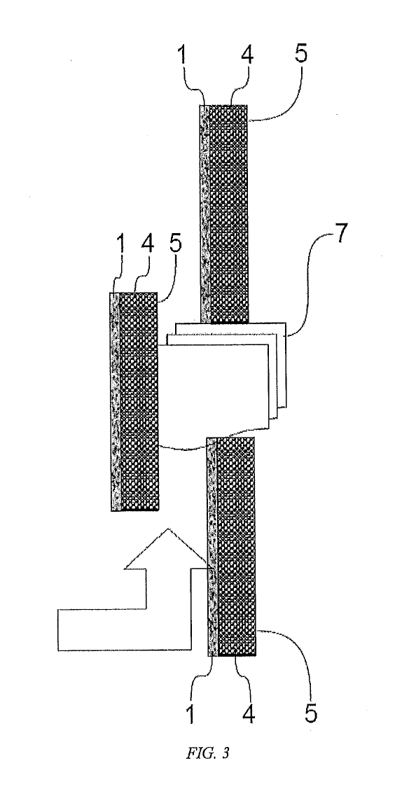

According to a further exemplary embodiment as illustrated in FIG. 3, the thermal efficiency of the enclosure can further be improved by providing an aperture to the enclosure wall and arranging a heat exchanging unit 7 proximate to the aperture. For protecting this part of the enclosure, an additional protecting hollow-core shell 1, 4, 5 can be mounted on top of the heat exchanging unit 7 so that there is an air gap for allowing sufficient air supply. The heat exchanging unit 7 can be a tube or plate heat exchanger or similar element. An alternative way would be to use a thermosiphon cooling system, for example, as disclosed in EP 2031332 A1 incorporated here in its entirety, so that protective flange as described above is provided on top of the element or the ribbing is removed from the section in contact with the absorption material. This would allow the fluid material to fill the cavities of the system giving it protection against gun fire.

Thus, it will be appreciated by those having ordinary skill in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. Method for providing a protective enclosure for equipment used in hostile environments, the method comprising:
forming an enclosure having an inner shell and an outer shell enclosing the inner shell at a clearance thereof, whereby a cavity is formed between the shells;
enclosing the equipment within the inner shell;
arranging granular absorption material as a protective layer into the cavity on site upon installation of the enclosure; and
providing an insulation layer between the outer shell and the absorption material, for filling at least part of a hole in the outer shell for preventing the absorption material from spilling out.

2. Method according to claim 1, comprising:
manufacturing and transporting the enclosure without the protective layer.

3. Method according to claim 1, wherein the granular absorption material is at least one of sand and soil.

4. Method according to claim 1, wherein the equipment is electrical equipment.

5. Outdoor equipment enclosure comprising:
an inner shell for housing equipment;
an outer shell enclosing the inner shell;
a cavity arranged between the inner shell and the outer shell on at least a portion of the enclosure for receiving a layer of material for absorbing penetrative kinetic energy, wherein the enclosure is adapted to receive fillable granular absorption material into the cavity on site upon installation; and
an insulation layer in the cavity on an inner surface of the outer shell, for filling at least part of a bullet hole in the outer shell for preventing the absorption material from spilling out.

6. Enclosure according to claim 5, wherein the insulation layer is made of porous material adapted to seal the outer shell from particles, such as dust.

7. Enclosure according to claim 6, wherein the insulation layer material is at least one of rubber and glass wool.

8. Enclosure according to claim 5, comprising:
an inlet for filling the cavity with absorption material upon installation; and
an outlet for draining out absorption material upon maintenance or disassembly.

9. Enclosure according to claim 5, comprising:
an aramid fabric layer for reinforcing the absorption material, the aramid fabric layer being arranged between the outer shell and inner shell.

10. Enclosure according to claim 5, comprising:
a pressure balancing tube for exhausting abrupt overpressure within the enclosure.

11. Enclosure according to claim 5, comprising:
a thermosyphon, extending from inside the enclosure to outside thereof for cooling the enclosure.

12. Enclosure according to claim 5, wherein the outer shell is made of sheet material, including at least one of steel, stainless steel, aluminum, plastics, glass fiber, and wood, having a thickness between 0.5 and 5 mm.

13. Enclosure according to claim 5, wherein the inner shell is made of sheet material, including at least one of steel, stainless steel and aluminum, having a thickness between 0.5 and 5 mm.

14. Enclosure according to claim 5, wherein the equipment is electrical equipment.

15. Enclosure according to claim 11, wherein the thermosyphon is a heat pipe.
